(19) United States
(12) Patent Application Publication
(10) Pub. No.: US 2020/0027181 A1
(43) Pub. Date: Jan. 23, 2020

(54) AUTOMATED HEALTH DATA ACQUISITION, PROCESSING AND COMMUNICATION SYSTEM AND METHOD

(71) Applicant: dacadoo ag, Zurich (CH)

(72) Inventors: Peter Ohnemus, Herrliberg (CH); Andre Naef, Zurich (CH); Laurence Jacobs, Thalwil (CH)

(21) Appl. No.: 16/536,158

(22) Filed: Aug. 8, 2019

Related U.S. Application Data
(63) Continuation-in-part of application No. 14/257,855, filed on Apr. 21, 2014.
Application No. 14/257,855 is a continuation of application No. 13/877,059, filed on Apr. 23, 2013, now Pat. No. 8,706,530.
Application No. 13/877,059 is a continuation-in-part of application No. 14/094,616, filed on Dec. 2, 2013.
Application No. 14/094,616 is a continuation-in-part of application No. 16/038,058, filed on Jul. 17, 2018.
Application No. 16/038,058 is a continuation-in-part of application No. 15/778,999, filed on May 24, 2018.
Application No. 15/778,999 is a continuation-in-part of application No. 15/313,513, filed on Nov. 22, 2016.
(60) Provisional application No. 61/387,906, filed on Sep. 29, 2010.
(60) Provisional application No. 61/495,247, filed on Jun. 9, 2011.
(60) Provisional application No. 61/732,203, filed on Nov. 30, 2012.
(60) Provisional application No. 62/533,557, filed on Jul. 17, 2017.
(60) Provisional application No. 62/409,329, filed on Oct. 17, 2016.
(60) Provisional application No. 62/383,027, filed on Sep. 2, 2016.
(60) Provisional application No. 62/341,421, filed on May 25, 2016.
(60) Provisional application No. 62/269,808, filed on Dec. 18, 2015.
(60) Provisional application No. 62/259,593, filed on Nov. 24, 2015.
(60) Provisional application No. 62/006,023, filed on May 30, 2014.
(60) Provisional application No. 62/002,370, filed on May 23, 2014.

(51) Int. Cl. G06Q 50/22

(52) U.S. Cl. CPC G06Q 50/22

(57) ABSTRACT

Modulated output from each of a plurality of models is integrated to quantify factors and generate a plurality of values, each within a continuous distribution. A respective discrete category is associated with some of the values to represent a likelihood of future occurrence. Values are received from a first, second, and third data model. The values are modulated to scale a value representing aspect(s) associated with the likelihood of the future occurrence. The modulating is based on at least one factor derived from at least one of the first data model, the second data model, and the third data model. Thereafter, the values are integrated as a function artificial intelligence comprised in the at least one computing device, and a respective discrete category associated with the integrated values is selected, wherein each of the integrated values and the selected category represent the likelihood of a future occurrence.

### CROSS-REFERENCE TO RELATED APPLICATIONS

This application is a continuation-in-part of U.S. patent application Ser. No. 14/257,855, filed Apr. 21, 2014, which is a continuation of U.S. patent application Ser. No. 13/877,059, filed Apr. 23, 2013, now U.S. Pat. No. 8,706,530, issued Apr. 22, 2014, which is a National Stage of PCT/US2011/053971, filed Sep. 29, 2011 and claims the benefit of U.S. Patent Application Ser. No. 61/387,906, filed Sep. 29, 2010, and U.S. Patent Application Ser. No. 61/495,247, filed Jun. 9, 2011, all of which are incorporated by reference, as if expressly set forth in their respective entireties herein. Further, this application is also a continuation-in-part of U.S. patent application Ser. No. 14/094,616, filed Dec. 2, 2013, which claims priority to U.S. Patent application No.: 61/732,203, filed Nov. 30, 2012, all of which are incorporated by reference, as if expressly set forth in their respective entireties herein. Further, this application is a continuation-in-part of U.S. patent application Ser. No. 16/038,058, filed Jul. 17, 2018, which is a continuation in part of U.S. Ser. No. 15/778,999, filed May 24, 2018, which claims priority from U.S. Patent Application No. 62/533,557, filed Jul. 17, 2017, and which is a national stage entry of PCT/US2016/063606, filed Nov. 23, 2016, which claims priority to U.S. Patent Application No. 62/409,329, filed Oct. 17, 2016, U.S. Patent Application No. 62/383,027, filed Sep. 2, 2016, U.S. Patent Application No. 62/341,421, filed May 25, 2016, U.S. Patent Application No. 62,269,808, filed Dec. 18, 2015, and U.S. Patent Application No. 62,259,593, filed Nov. 24, 2015, all of which are incorporated by reference, as if expressly set forth in their respective entireties herein. Further, this application is a continuation-in-part of U.S. patent application Ser. No. 15/313,513, filed Nov. 22, 2016, which is a national stage entry of PCT/US2015/32462, filed May 26, 2015, which claims priority to U.S. Patent Application No. 62/006,023, filed May 30, 2014, and U.S. Patent Application No. 62/002,370, filed May 23, 2014, all of which are incorporated by reference, as if expressly set forth in their respective entireties herein.

### FIELD OF THE INVENTION

The present application relates, generally, to automated health data acquisition and, more particularly, to automatically optimizing values associating with probabilities of future events.

### BACKGROUND

Providing a quantitative assessment of an individual's health is complex and involves consideration of various factors. While some assess health in view of exposure to various hazards and health risks, other factors are often not considered, such as factors which derive from aspects of the individual's quality of life and lifestyle. Further, although broad definitions of health are known, such definitions are often qualitative, or semi-quantitative at most, and assessments often do not use a holistic approach for a quantitative determination of health.

Assessments of health are often made by measuring the absence of health, or the presence of disease typically in a severe state, which may be measured by a physical evaluation, objective procedures, and tests. Further, traditional assessments of health relate to morbidity and the risk of mortality. In such cases, measurements may be quantified, however they may reveal little about other important health components and, thus, be misleading. Accordingly, deriving a single number, such as a quantitative score, as a consistent and accurate measurement of an individual's health represents a considerable challenge.

Any holistic approach to measuring or assessing a person's health includes at least some degree of information based on self-assessment. Obtaining accurate and current self-assessed information can be problematic, particularly when participants do not provide information regularly and consistently. Unfortunately, participants often stop providing accurate and current self-assessed health-related information, particularly when platforms prompting for such information are not particularly easy, engaging, and/or attractive.

Furthermore, known health-assessment inductive models (i.e., models derived directly from data) do not (or cannot) include all possible predictors. This is partly because not all relevant predictors of a particular event are ever known, but also in part because some known predictors may be difficult or impractical to measure. Moreover, it is recognized herein that known models that are built using data collected from a given population and that are usable to summarize and generalize morbidity and mortality characteristics of the population, inaccurately provide risk estimates derived from other populations. Thus, relevant predictors may not be included in existing model(s) and can differ significantly between two distinct populations. This can result in employing predictive models that underestimate or overestimate a particular risk.

### SUMMARY

A computer-implemented system and method are disclosed herein for integrating modulated output from each of a plurality of models to quantify factors to generate a plurality of values. Each of the values are within a continuous distribution. A respective discrete category associated with each of the values is selected representing a likelihood of a future occurrence. In one or more implementations, a first data model running on at least one computing device quantifies each of a plurality of endpoints that contribute to a current state and the likelihood of the future occurrence, wherein each quantified value of the respective quantified endpoints is calculated within a continuous distribution. Further, a second data model running on at least one computing device generates respective values representing aspects of at least one present condition that impact the likelihood of the future occurrence, wherein each of the respective generated values is within a continuous distribution. Still further, a third data model running on at least one computing device identifies individual ones of a plurality of factors associated with a subset of the endpoints and/or the aspects that are individually modifiable. A value is generated within a continuous distribution representing each of the plurality of factors.

Continuing with one or more implementations of the present application, a modulating model running on the computing device(s) can modulate at least one value quantified by the first data model, generated by the second data model and/or identified by the third data model, to scale a value representing at least one aspect associated with the likelihood of the future occurrence. The modulating can be based on at least one factor derived from at least one of the first data model, the second data model, and the third data model. Moreover, at least one of artificial intelligence and machine learning can be comprised in the at least one computing device and used to integrate at least two of the values associated with each of the plurality of continuous distributions. A respective discrete category associated with the integrated values can be selected, wherein each of the integrated values and the selected category represent the likelihood of a future occurrence.

In one or more implementations of the present application, at least one computing device imputes at least one value that is not included in a set of inputs used by the first data model.

In one or more implementations of the present application, at least one computing device imputes at least one other value that is not included in the previously imputed value(s) or the quantified value associated with the previously quantified endpoint, wherein the at least one other imputed value depends on at least one of the previously imputed values. Further, the at least one other value is within a continuous distribution.

In one or more implementations of the present application, at least one computing device recalibrates at least one of the first data model, the second data model, and the third data model as a function of information received over time or information received from a plurality of data sources.

In one or more implementations of the present application, the first data model uses the respective endpoints as composite input features in a fitting procedure.

In one or more implementations of the present application, at least one computing device configures a user computing device with a software application that provides a graphical user interface on the user computing device, wherein the user computing device receives at least some of the values and the aspects from a user operating the user computing device. Further, the at least one computing device receives over a data communication session at least some of the values and aspects, and the at least one computing device transmits to the user computing device, the quantified values associated with the at least some of the endpoints, the quantified values associated with the at least some of the aspects, and the generated values associated with at least some of the factors respectively from the first data model, the second data model, and the third data model. Moreover, the user computing device is further configured by the software application to display the received values received from the at least one computing device.

Moreover, in one or more implementations of the present application at least one computing device configures a user computing device with a software application that provides a graphical user interface on the user computing device, wherein the graphical user interface regularly and periodically prompts a user to enter values associated with the factors, and further wherein the graphical user interface automatically provides interactive display screens when values associated with the factors are not received subsequent to previously received values.

Further, at least one of the first data model, the second data model and the third data model can comprise a selection of at least two other data models. Still further, the values can be calculated in the continuous distribution as a function of parametric non-linear mapping. Still further, at least one of the first data model, the second data model, and the third data model can comprise at least one of artificial intelligence and machine learning.

These and other aspects, features, and advantages can be appreciated from the accompanying description of certain embodiments of the invention and the accompanying drawing figures and claims.

### BRIEF DESCRIPTION OF THE DRAWINGS

Various features, aspects and advantages of the invention can be appreciated from the following detailed description and the accompanying drawing figures, in which:

FIG. 1A is a block diagram illustrating models, components, and a generated metric health score as a function thereof, in connection with an example implementation of the present application;

FIG. 1B is a block diagram illustrating components associated with a plurality of models and process(es) associated with modulation, in accordance with the present application;

FIG. 1C shows a graph representing accuracy of an imputation engine in accordance with an example implementation;

FIG. 1D illustrates a distribution of an un-equalized score (plotted in the upper panel), and a distribution of a corresponding equalized score;

FIG. 2 is a block diagram illustrating a hardware arrangement in connection with an example implementation of the present application;

FIG. 3 shows example components and configurations of computing devices that can be used to implement the techniques described herein;

FIGS. 4-8 illustrate example screen displays associated with a graphical user interface that is operable to provide features described herein; and

FIGS. 9A and 9B illustrate example screen displays associated with an example data conversion process in an implementation of the present application.

### DETAILED DESCRIPTION OF THE EMBODIMENTS

By way of overview and introduction, the present application includes systems, techniques and interfaces for data processing, including for collection, design, modeling, simulating, and generating information associated with health of an individual. Such information can include particular factors of an individual's health, as well as a more general state of an individual's health at a given time, in the past, or in the future. Moreover, the present application includes systems and methods for transforming collected and/or generated information, and for interfacing with computing platforms to increase operations associated with such devices and/or otherwise influence operations associated with such devices as a function of such transformed information.

The present application provides health assessment in accordance with a multidimensional framework that includes premature mortality and life expectancy estimates, as well as various degrees of physical, emotional, and cognitive factors. Such factors can be measured or may be based on an individual's perception about his or her current state of health as well as prospects for future health in view of possible lifestyle changes. Accordingly, each person's state of health is assessed, at least in part, on degrees to which an individual's quality of life can be altered by behavioral and lifestyle modifications.

Systems and methods of the present application include one or more modules that estimate respective probabilities associated with an individual who is suffering one or more serious health events over a given time horizon. In one or more implementations of the present application, such estimates include probabilities based on models which are built using observed characteristics of associated subjects within one or more populations. For example, measurements of variables are taken for a set of subjects at a certain point in their lives to generate a baseline. Thereafter, the subjects are tracked and a set of metrics for the subjects are recorded over time. Using these data and applying the data to health events or end points, such as stroke, cancer, or myocardial infarction, mathematical models can be built and usable to estimate probabilities that an individual will suffer one or more of such events over time. A set of baseline measurements of variables can be generated that are used as statistically relevant predictors of various health-related events. A time lag between the time when predictors are measured and a corresponding target health event that is predicted by such models can be used to calculate a “Survival Probability” value, notwithstanding that not all target events are necessarily fatal.

The present application can implement one or more mathematical models that have been validated and maintained, including by periodically recalibrating the models' parameters using new data. For example, a model derived from data can be validated using information received from one or more sources, such as survey data received from the National Health and Nutrition Examination Survey (“NHANES”). The present application can include operations to update one or more models by including additional covariates that are observed to correlate with the recorded frequency of one or more target health-related events. For one simple example includes a Framingham risk function, where recalibration is performed using a variety of possible techniques, such as Logistic Regression or Cox Proportional Hazards models as applied to a separate data set, such as NHANES III.

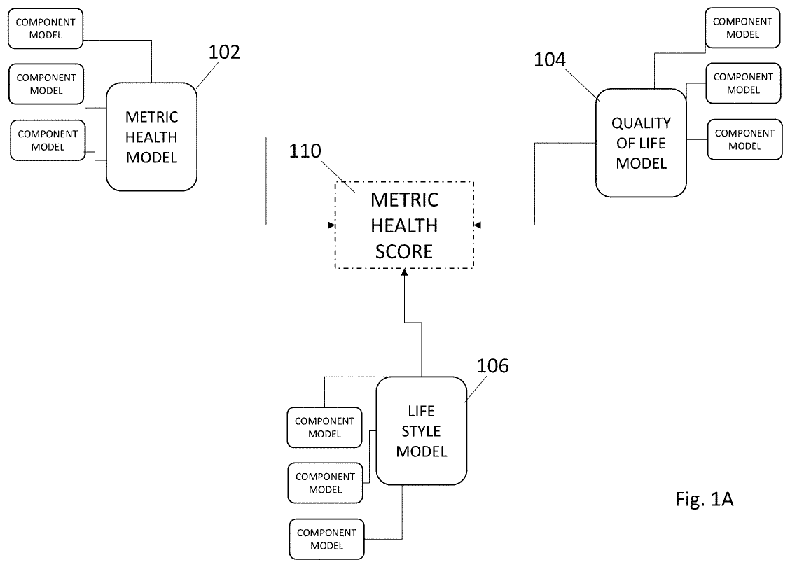

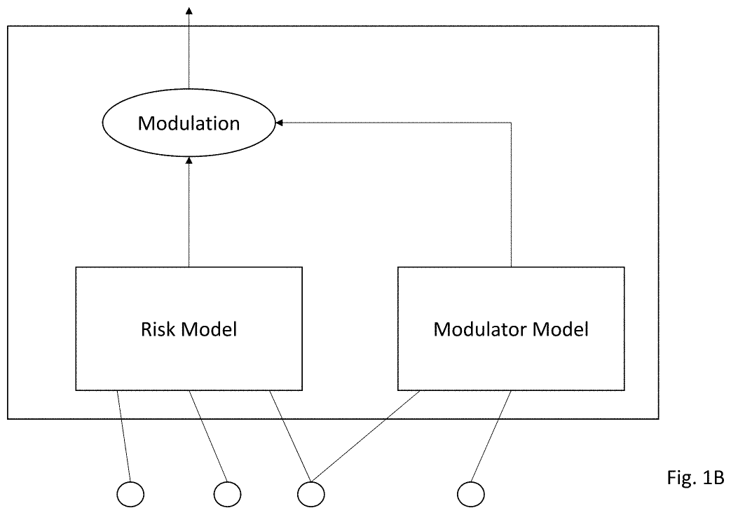

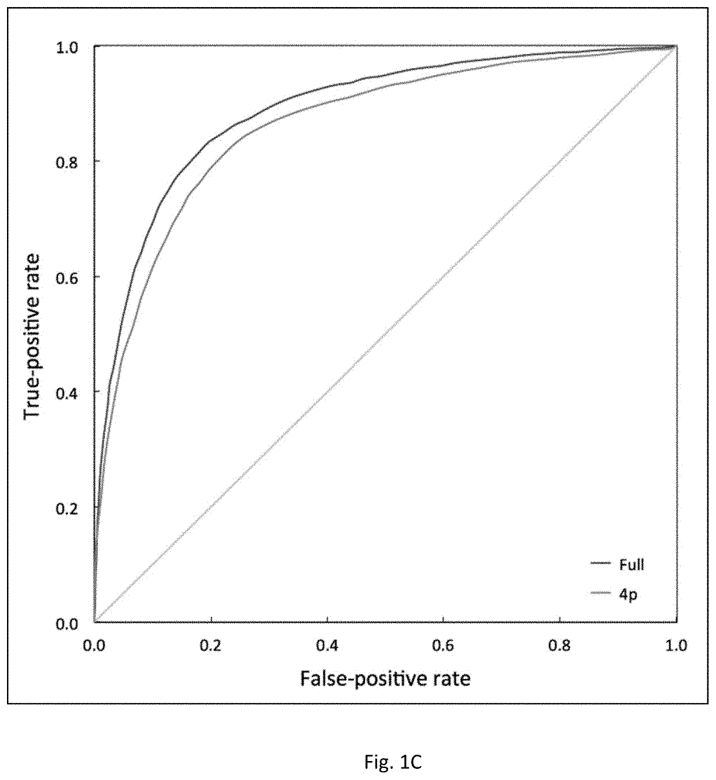

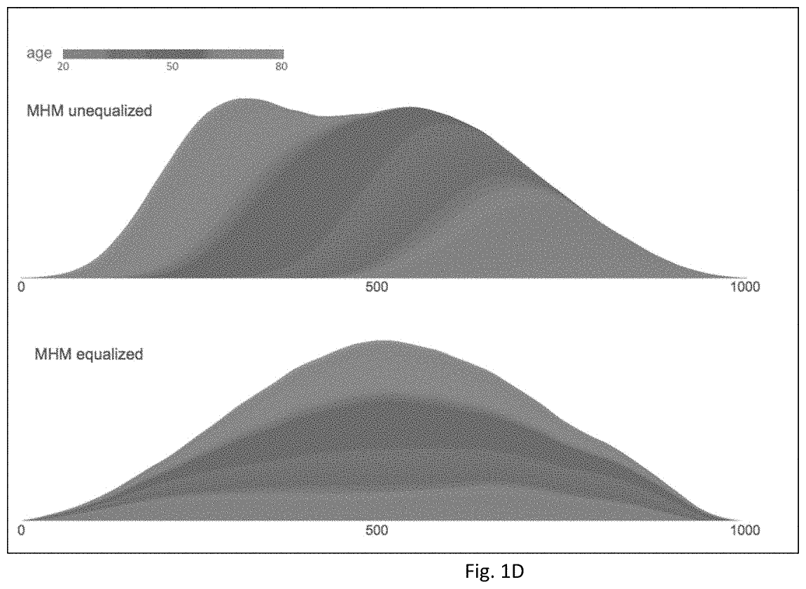

Referring now to the drawings figures in which like reference numerals refer to like elements, FIG. 1A is a simple block diagram illustrating a plurality of models (Metric Health Model 102, Quality of Life Model 104, and Lifestyle Model 106), as well as respective components (e.g., models) that are used in the creation and/or formation of models 102, 104, 106. Moreover, and as described in detail herein, output from models 102, 104 and 106 are usable to generate a Metric Health Score 110 which, among other things, provides a quantification of a user's health, that is highly personal and contextual, yet preserves private health-related details associated with a person. FIG. 1B is a block diagram illustrating components associated with a plurality of models (a risk model and a modulator model) and process(es) associated with modulation, as shown and described herein.

More specifically, the present application can include a particular mathematical model, referred to herein generally as a Metric Health Model (MHM) 102, which can be employed to quantify an extent to which each of a series of measurable health-related parameters, such as blood pressure or total cholesterol, impacts the state of health of an individual. More particularly, the MHM 102 can be used to measure the extent of measured parameters impacting the risk that an individual will develop a respective health condition in the future. In one or more implementations, the MHM 102 is derived using data from existing and on-going studies, as well as existing metric health survival models.

In one or more implementations, the MHM 102 can be based on data and predictive risk models of cardiovascular and cerebrovascular end-points, and can further include one or more cancer risk models. The MHM 102 can include selection of particular models, which can be combined in particular ways, for generating a general measurement of an individual's overall health. Moreover, risks can be weighed by combining probabilities, or by using an averaging procedure, which leads to a good estimation and definition of an aggregate risk probability. In one or more implementations, models can be combined at two levels: (1) as a simple approximation, such as a direct arithmetic average of the corresponding risks; (2) more accurately by using either hazard ratios or the risks themselves as composite features to use in a fitting procedure, such as building Cox Proportional Hazards models. In one or more implementations, even though the MHM 102 excludes one or more explicit cancer risk models, assessment of risk is supported for individuals who are at risk for a wide variety of cancers, as well as other diverse medical conditions, such as gastro-intestinal disorders and Alzheimer's disease, which may be excluded. Accordingly, the MHM 102 of the present application is usable to generate accurate predictions of very general aggregated health metrics. Moreover, the MHM 102 of the present application is similarly usable to generate accurate predictions associated with long-term and short-term future healthcare costs for an individual. Still further, the MHM 102 is operable as an accurate survival predictor.

In addition to the MHM 102, the present application can include a particular mathematical model, referred to herein generally as a Quality of Life Model (QLM) 104. The QLM 104 can be derived from quantified aspects of an individual's health that are significant for determining an accurate measurement of the individual's health with regard to the individual's quality of life, notwithstanding such factors being difficult to quantify. For example, certain factors associated with an individual who is bedridden with severe chronic pain, or factors that are associated with debilitating depression, can impact materially an individual's quality of life and that individual's potential risk of contracting a disease. These and other qualified factors have traditionally been considered of lesser or secondary relevance in assessing value representing an individual's health, at least in part because such values are difficult to measure and quantify in an unambiguous way. The present application's application of the QLM 104 resolves such concern and quantifies such factors, at least in part by including self-assessed factors that are usable to estimate a numerical value representing an individual's quality of life.

In one or more implementations, self-assessment can be received from user computing devices as a function of modules operating on such devices that provide prompts for various factors in the form of questions and/or comments in an interactive computing program platform. Such factors can be recognized as common to both metric and self-assessed health estimations. The prompts and software platform providing such prompts in accordance with the present application can be configured to ensure that received self-assessment is current and accurate, thereby ensuring statistically significant correlations between qualitative assessment (e.g., how an individual feels) and an accurate and realistic measure of health. Further, at least semi-quantitative measures representing an individual's quality of life can be generated. Various effects of an individual's diverse affective disposition, such as mood, emotional state, and the like, can be taken into consideration by the QLM 104 with regard to cardiovascular and other health-related risks.

Thus, the MHM 102 and QLM 104 as applied in accordance with the present application provide both a quantitative and comprehensive view of the current state of health of an individual, and account for many health-related factors, including as determined from hereditary, familial data, pre-existing conditions, anthropomorphic, demographic, inflammatory, and metabolic data, lifestyle data, and self-assessed data.

In addition to the MHM 102 and QLM 104, the present application further can include a particular mathematical model, referred to herein generally as a Lifestyle Model (LSM) 106. The LSM 106 can be employed to estimate likely future impacts on an individual's health as determined from the individual's current lifestyle, including various lifestyle-related risk factors. Such negative and/or positive factors can include, for example, drinking, smoking, drug use, exercise, diet, and the like.

While not a clinical tool, per se, that identifies and quantifies risk factors as causes of overall health risk, the present application operates to derive a plurality of measurements. The measurements are combinable or otherwise used to calculate a relative measurement representing a current state of health of an individual, as well as the probable best avenues for the improvement of state of health. The presence or absence of any particular measurable factor in an individual that is found to be quantitatively and significantly correlated with health risk, independently of the direction of probable causality, is paramount to determining a representation of a current state.

In one or more implementations, the MHM 102 can be derived from estimates of cardiovascular, cancer, and other risks associated with measurable parameters, such as age, gender, blood pressure, weight, and lipid levels. These factors are associated with the most common vascular, cancer, and other risks. As examples, the predictive accuracy of many existing risk functions (e.g., Framingham, AHA-ASCVD) that use as input one or more binary, categorical values for a risk-modifying disease, such as hypertension, can be improved by substituting the categorical factor by a suitable probability of developing such disease over a period of time. Thus, instead of assigning a YES/NO (1/0) value to, say, type II diabetes, we may assign the probability of the person becoming diabetic over time from a separate model that quantifies the risk of developing diabetes. If the person is already diabetic at baseline, this model will produce a YES (1), but it will produce a continuous, non-zero value for every other case.

In some implementations of the present application, inputs are transformed (e.g., logarithmically) depending on individual data characteristics. In other cases, interaction terms, such as a product of two of inputs are included as additional features. In yet other cases, more complex features are constructed, such as from either elementary inputs (e.g., age or blood pressure), or complex combination of elementary inputs.

The overall MH Score 110 can broadly include factors that cover a set of disease end-points and associated risk factors, including precursor risk factors and central risk factors. Precursor risk factors include risks that are associated with major diseases, such as Type 2 Diabetes or Hypertension, while central risk factors include risks associated with major vascular and cancer-related fatalities. In addition, modulator models can operate to modify (or module) the output of models associated with the respective factors. For example, modulator models can operate to scale risk using factors that may not explicitly be included, such as physical activity, psychosocial state, alcohol consumption or certain aspects of nutrition. Modulators can include predictors derived from the QLM 104 and LSM 106, each of which can include several separate models that are combined to produce a single event risk estimation.

More particularly, example risk factors included in MHM 102 as precursor risks can include: diabetes; hypertension; chronic kidney disease; and index of metabolic dysfunction. Example modulators used in MHM 102 can include: alcohol and coffee consumption; physical activity; nutrition; resting heart rate; heart rate recovery; smoking cessation; and affective state. Example disease and end-points in the MHM 102 can include: cardiovascular risks (including general cardiovascular disease, coronary heart disease, congestive heart failure and myocardial infarction); cerebrovascular risks, and a broad range of cancer risks.

The MHM 102 can be built to ensure a maximum prediction horizon of approximately a fixed period of time, such as 10 or 15 years, and can include various lifestyle factors, such as physical activity, smoking, and nutrition, among others. Moreover, the present application employs machine learning techniques that optimize one or more models. Many of the individual models, such as various models employed to estimate risk of diabetes, are fit to data that use specific, traditional, techniques, such as Cox Proportional Hazards models or one of several types of Logistic Regression models. In one or more implementations of the present application, the train/test cycle is done similarly to known machine-learning techniques. More particularly, A fit is done using a randomly-chosen percentage (e.g., 70%) of the records, and testing is performed using the remaining 30% of the records. A plurality of individual models can be used in a combination of several models into a single predictor.

Moreover, precursor risks can include modulators as modifiers. The input data for modulator models can be from several sources, including data received in response to prompts provided on one or more computing devices, wherein the data represent familial, demographic, metabolic, values. Moreover, inputs can include parameters derived from models using these inputs, data derived from the QLM 104, as well as information provided substantially in real-time from technology tracking intrinsic medical and/or extrinsic behavioral activity.

With reference to FIG. 1B and by way of example, a model (“A”) estimates the risk of cardiovascular death. A set of inputs (“S”) is provided to model A. A modulator risk model, (“A′”) has an input set (“S′”), which is not a subset of S. In effect, S′−S≠Ø. A′ modifies the output of model A. By way of further example, S (i.e., the input set of model A) does not include resting heart rate, notwithstanding that heart rate is an important risk factor for predictions provided by model A. Continuing with this example, model A′ can be a simple model that outputs predictions of cardiovascular death based only on resting heart rate. By modulating model A with model A′, the present application improves the predictive capabilities of model A. Technically, the modulation is preferably performed at the level of hazard functions. The output of model A is thus modulated to include an additional input. As illustrated in FIG. 1B, the combination of model A, model A′, and the modulation, functionally operates as a new risk model.

The MHM b 102 operates effectively and accurately by using inputs received from a user that are generally simple and inexpensive to obtain. Recognizing that inherent constraints exist on component models that would otherwise be available, the present application automatically imputes various values associated with risk factors that are difficult or expensive to obtain. This enables users to obtain a MH Score 110 simply by supplying a minimal set of values, (e.g., age, gender, height, and weight), and other values associated with one or more risk factors are imputed automatically. To increase accuracy of the MHM 102 (and, consequently, the MH Score 110), interactive processes and mechanisms are provided that incentivize users to provide additional data that will make respective scores more accurate and meaningful.

Moreover particularly, in one or more implementations the present patent application incorporates an imputation engine that operates to impute missing values in a hierarchical fashion and in particular order(s). For example, an imputation stream is provided at a given level that may use all data, including input or data that was previously imputed to impute one or more other missing values. Of course, one of ordinary skill will recognize that the overall accuracy of any given imputed value can depend on the accuracy of one or more previously imputed values. Accordingly, the order in which values are imported can be of considerable relevance. Given any set of inputs, such as age, gender, height, and weight, additional inputs can be imputed using population models that include the given set of inputs, and one or more additional inputs to approximate. The order of imputation can be significant, as the order can determine the overall accuracy of the imputation procedure. For example, imputing total cholesterol and, thereafter, imputing fasting glucose will not necessarily produce the same results as imputing these variables in the opposite order. The optimal order, for a given dataset, can be obtained using explicit computation and standard optimization procedures.

A quantitative determination representing the accuracy of the imputation engine of the present application can be obtained by comparing an unoptimized implementation of the MHM 102 for a substantially full set of variables (denoted as “Full,” below) with the corresponding results for the same dataset, but with input restricted to Age, Gender, Height, and Weight, which are required by the engine (denoted by “4p” in the table below and in the graph illustrated in FIG. 1C). The comparison represents a case with a substantial input set with only the missing variables imputed, and a case in which all input variables other than age, gender, height, and weight, have been imputed by the imputation engine. For the purpose of this comparison, an ROC curve is shown to contrast accuracy in identifying the true positive cases (sensitivity) with that of incorrectly identifying survivors (1-specificity). The thin diagonal line in the graph shown in FIG. 1C corresponds to the result of a random classifier, and points above this diagonal indicate a classifier that is better than, say, a random classifier. A common measure of the quality of a classifier is the area under the corresponding curve (AUC or C-statistic). More particularly, the corresponding AUC values for the prediction of all-cause mortality in the National Health and Nutrition Examination Survey (NHANES) III study for the two cases, without any additional optimization, are as shown in the table below.

| case | AUC |
|---|---|
| Substantial input set | 0.9034 |
| Age, gender, height, weight | 0.8612 |

In the example graph shown in FIG. 1C, the ROC curves compare the predictive ability of all-cause mortality in connection with an imputation engine using either the full available input set, or only the four minimum inputs (i.e., age, gender, height, weight). In the above example, the global effect of a maximal number of missing values is a reduction of about 4% in the AUC, which represents a loss in predictive power. In one or more implementations, a derived value representing an aggregate all-cause mortality risk is converted into a numerical score (e.g., the MH Score 110) in the range [0,1000], with zero signifying the complete absence of health, and 1000 signifying perfect (unattainable) health. In addition, a separate score that is closely related to the MH Score 110 is presented with or without the MH Score 110 to the user, which is a relatively simple and intuitive score. The simplified score is based on an estimate of the all-cause mortality risk of the user and represents a relative life expectancy, which further represents effects of various lifestyle factors that are available to an engine. The value can be presented as a number of “Quality Years Gained.” Thus, the present application further protects sensitive and private user health information by displaying or otherwise providing the simplified score, with or without the MH Score 110, while simultaneously keeping sensitive health-related information that is received (and/or imputed) concealed.

It is recognized herein that age is a significant risk factor for almost all diseases. An unmodified health score value that is derived from general risk models would not be sufficiently accurate to be used as a universal metric to represent relative health all across age groups. Accordingly, age is a usable as a modifier factor and that impacts output generated by one or more models. Similarly, gender is used herein as a modifier of one or more health risk models, thereby eliminating inaccuracies. For example, an unmodified health model which is based solely on risk is modified as a function of gender in order to treat men and women differently. Accordingly, the derived MH Score 110 of the present application can be approximately independent of both age and gender, as a function of a mechanism of equalization that involves modifying a base score calculated using the MHM 102, and equalizing that score using a model derived from a large population study.

The graphs shown in FIG. 1D illustrates distributions of an un-equalized score (plotted in the upper panel), and a corresponding equalized score plotted in the lower panel. The distributions represent chronological age, as shown in the legend. While the un-equalized score is strongly influenced by age, the equalized version is shown to be approximately age-independent, as desired. For any given gender and age range, however, the variation in the actual score for given gender and age group is still a relative measure health of users in that gender and age range.

Referring to the graphs shown in FIG. 1D, the distributions of the un-equalized score are shown in the upper panel, and the corresponding distributions of the equalized score are shown in the lower panel. The gradations in the distributions represent chronological age, as shown in the legend. It is recognized herein that a determination whether the MHM 102 provides an accurate general model of relative health, particularly as modified in accordance with the teachings herein, can be ascertained through validation. Accordingly, two types of retrospective validation approaches are implemented herein: i) a comparison between the MH Score 110 and well-established and prospectively validated general and/or specific health risk models, such as the Framingham heart-related model; or ii) a direct confrontation of the MH Score 110 with linked mortality data from one or more large studies.

The results of the validation show that (1) the MH Score 110 is consistent with well-known and previously validated cardiovascular risk models; (2) when functioning as a disease and mortality classifier, the MH Score 110 is highly accurate, considerably more so than any score produced by a single model used in its construction, and, furthermore, (3) the MH Score 110 is a very accurate classifier for mortality risk in a wide variety of cancers even without directly implementing cancer-risk models in the MHM 102. Accordingly, the MHM 102 is operable as a general health model assessment tool than would be otherwise presumed in view of its constituent models. Perhaps more significantly, the MHM 102 validates that a variance in the set of risk factors included in MHM 102, of which many (possibly most) are modifiable through lifestyle change, is strongly indicative of decaying health in general, beyond risks of mortality resulting from cancer and/or vascular disease.

As noted herein, one output of the MHM 102 is a score that is scaled to a range, [0,1000], with the top end signifying perfect (unattainable) health. In one or more implementations of the present application the MH Score 110 can be derived in accordance with a two-step process. First, an overall raw score is obtained by combining survival probabilities and other scores generated by individual risk models. The combination of survival probabilities can be done using any one of several procedures, such as direct arithmetic averaging, Euclidean averaging, or using the separate probabilities as features in a secondary fitting procedure, using the separate survival probabilities themselves as composite features to use in a secondary fitting procedure, such as building Cox Proportional Hazards models using these features. The calculated raw score represents a resulting survival probability, which is a number in the range of [0,1]. The calculated raw score is, thereafter, transformed using a parametric nonlinear mapping function, and into a value in the range of [0,1000]. The parameters of the mapping function are tuned so that the scores are linear, with a relatively high slope in the region of typical polled scores. Further, the scores asymptotically slope off in the low and high ends of the score distributions. Accordingly, the mapping function is designed to be strongly reactive to changes in the typical score region.

Referring back to the Quality of Life Model (“QLM”) 104, in one or more implementations of the present application, data from a sample of over 4,000 surveys completed by international organizations were used for model building. Of the original sample, nearly 3,250 complete surveys were used to build the QOL model. Data from the remaining incomplete surveys were excluded from model-building, but still used for basic statistical quality metrics. Unlike traditional questionnaire-based approaches, in which questions can be assigned ad hoc weights based on the researchers' belief of a relevance associated with respective questions, the QLM 104 of the present application is derived as a causal model, including factor loadings, directly from the data used from the surveys. Deriving the QLM 104 as a causal model enables important risk factors to be derived, including levels of depression and stress experienced by an individual. Derived risk factors are, thereafter, usable as input for other models. Moreover, and unlike traditional quality of life models that produce a single static value, the results of the QLM 104 can be dynamically and regularly updated as a function of input from a single user. Updated QLM 104 results can reflect changes in an individual's perception and general feeling of wellness over time.

In one or more implementations of the present application, a questionnaire associated with the QLM 104 includes 25 questions that are designed to quantify the major affective states of depression, hopefulness, wellness, anxiety, and psychological stress. The relatively small sample set of questions are representative of those included in one or more large sets of questions, and are usable to develop a relatively short instrument that could quantify the major affective states consistently.

More particularly, the QLM 104 can be built as a causal model using inductive clustering and factor analysis. In one or more implementations, a final factor model can be built using a 10-fold cross-validation approach using approximately 70% of one or more surveys for the learning set, and the remaining 30% for the testing set. In one or more implementations, a set-aside set of approximately 500 surveys can be used for final model validation. An optimal resulting set of four natural clusters or factors with a self-consistent interpretation and good statistical properties includes: C1=Depression (α=0.81), C2=Hopefulness (α=0.89), C3=Wellness (α=0.84), C4=Stress (α=0.80). The final loadings for each factor were estimated as the coefficients of the first principal Karhunen-Loève component.

Unlike the MHM 102 and QLM 104, which collectively address a current health of an individual, the LSM 106 addresses lifestyle-related risks to estimate future health of an individual, which are largely modifiable and operable to improve an individual's health. It is recognized herein that several lifestyle elements can have a critical impact on a user's health. Three non-limiting examples of such elements include smoking, physical inactivity and poor nutrition, which represent significant health risks that are modifiable.

In one or more implementations, the LSM 106 comprises several components, each of which is configured to generate a respective score, and generally based directly on a respective risk model. Examples of components that can be included in the LSM 106 include: physical movement; nutrition; weight management; smoking cessation; stress reduction; sleep quality; and sleep duration. In one or more implementations, inputs associated with such components that can be included in the LSM 106 are provided via manual user input, or various electronic sensors that are integrated into the system, e.g., via the Internet of Things (“IoT”). Example IoT devices and/or components include, but are not limited to, smart rings, configured glasses, configured contact lenses, hearing devices, clothing accessories (e.g., smart shoes, configured gloves) and other wearable devices.

For example, one or more biosensors can be used to collect and transmit health information about a user to one or more computing devices. The biosensor can be placed in contact with or within a user's body to measure vital signs or other health-related information of the user. For example, the biosensor can be a pulse meter that can be worn by the user in contact with the user's body so that the pulse of the user can be sensed, a heart rate monitor, an electrocardiogram device, a pedometer, a blood glucose monitor or other suitable device or system. A biosensor in accordance with the present application can include a communication module (e.g., a communication subsystem) so that the biosensor can transmit sensed data, either wired or wirelessly. The use of biosensors provides a degree of reliability by eliminating user error associated with manually entered and/or self-reported data. Moreover, wearable smart IOT devices, such as those that track fitness and sleep, are supported in accordance with the present application. Further other devices, such as implanted chips, voice-based interfaces, ultra-thin (e.g., tattoo-style) bio sensors or other interfaces are supported and usable for providing medical data that are usable in modeling and associated generated information shown and described herein.

Moreover, one or more computing devices, including a server, a smartphone, a laptop, tablet or other computing device can send and receive electronic content to/from a health band that is worn by a user. The content may include, for example, numerical, textual, graphical, pictorial, audio and video material. Such communications may occur directly and/or indirectly, such as between the server and a band via a mobile computing device such as a smart phone, tablet computer or other device. Alternatively, such communications may occur between the server and the health band without the use of computing device. Thus, in one or more implementations, a band may employ hardware and software modules that collect and/or receive information, process information, and transmit information between a band and a server and/or between the health band and a mobile device.

The output of each respective component is designed to maximize user motivation and, therefore, improve a likelihood that one or more of the significant health risks will be improved. The LSM Score can include a combination of various and separate scores, for example, from physical activity, sleep quality and duration, nutritional quality, and stress-reduction, among others. The LSM 106 is operable to generate a score for each of its respective components, such as weight management, sleep, nutrition, or the like. In addition, the LSM 106 can provide an aggregate score. Component scores can be based on a double buffer mechanism with a time-decay function. The scoring algorithm can use two energy repositories: the score repository, from which the score is computed, and a buffer repository. When a user exercises, the energy generated is split into these two repositories at a fixed ratio, with the majority of the energy going into the buffer repository. To simulate the realistic medical value of exercise, the energy accumulated in both repositories should decay over time (i.e., the positive effect of exercising one day has finite duration). However, if the user does not exercise the following days, for example, the energy level in the score repository will only drop when the buffer repository empties. With this mechanism the score does not fluctuate wildly and allows for rest days with no score penalty. This represents a medically realistic time delay between a sequence of specific activities, such as physical workouts, and the time when such a sequence delivers measurable health benefits to an individual. Moreover, the models associated with the LSM 106 can include a strongly motivational gaming structure that can directly connect with an achievements-based framework.

It is recognized herein that exercise and other physical activities can have a direct impact on an individual's health affect health directly when done consistently and only in a delayed fashion. The various corresponding components of the LSM 106 are based on models that implement these qualities in a medically realistic fashion. Moreover, the components are designed to provide a user with immediate positive results for beginning a lifestyle change to keep motivation going.

In one or more implementations, one or more components, such as in connection with physical activity, has a corresponding model that contains two reservoirs having a fixed maximum size. For example, one of two principal components (an “H” component) contributes directly to the overall MH Score 110. The second component (a “B” component) is a health buffer that contributes an elasticity component to the H component. For example, when a user tracks a physical activity, a small fraction of a score corresponding to the activity is added directly to H, while most of the score is added to B. The score, however, has a limited lifetime and decays to zero over time. The decay rate associated with the score is nonlinear, with its value depending on the current magnitude of both H and B and being applied directly to B, as long as B is greater than zero. When B is decreased to 0 through this decay, the decay is applied to H, which has a directly impact on the overall score for the component. The relatively fast decay of the health buffer provides a strong incentive for a user to maintain the value of the health buffer so as to not reduce the user's overall health score.

The above-described mechanism associated with the LSM 106 provides a medically accurate measurement associated with a user's efforts associated with good health maintenance or improvement. The value depreciates to zero if not maintained through consistent activity. The nonlinear nature of the decay function adapts itself to different levels of the corresponding activity: it is most demanding for the most active lifestyles and most forgiving for lower activity lifestyles. Conversely, low-level activity will not lead to high overall scores, thus rewarding higher and sustained levels of activity.

It is to be understood that the MHM 102, QLM 104, and the LSM 106, referred to herein, generally, as the “three pillars,” do not have to operate independently of each other, and output from each of the respective models are reflected in the MH Score 110, which also reflects interactions between the respective models. As noted herein, maintaining and/or improving an individual's future health is a key feature of the present application, the MH Score 110 can have an individually varying sensitivity to modifiable lifestyle behaviors.

In one or more implementations, scores associated with each of the three pillars are combined into the overall MH Score 110, which can be static and/or dynamic, in various implementations. The following table illustrates example percentage contributions to the MH Score 110 associated with each of the MHM 102, QLM 104, and LSM 106.

| | |
|---|---|
| Metric Health Model | 40% |
| Lifestyle Model | 45% |
| Quality of Life Model | 15% |

In addition to the effectiveness of the MH Score 110 on a personal level in connection with improving and/or maintaining an individual's health, the present application further includes an interactive data processing platform which includes data modeling and machine learning in connection with respective risk factors. Referred to herein, generally, as a “Risk Engine,” the present application provides for systems and methods associated with decision-making based on health risks. In particular, risk factors can be quantified in a continuous distribution and with extremely precise specificity and, thereafter, one or more cutoff values associated with classification and stratification can be defined and/or selected as a function thereof. Output values associated therewith are usable to influence third party applications, such as in connection with insurance.

Despite conceptual similarities between the output of the Risk Engine and traditional actuarial tools, for example, used in life insurance, there are distinguishing characteristics and features of the present application that are not supported or otherwise included in an actuarial application. Perhaps most notably, output of the present application, including the MH Score 110, or respective scores that are output as a function of the MHM 102, the QLM 104, and the LSM 106, as well as respective components associated therewith, are continuous measurements, as opposed to discrete, table-based risk estimates.

As noted herein, output is calculated in connection with the MHM 102, QLM 104, and LSM 106, as well as component models thereof, which regard a continuous probability space between 0 and 1 which, in one or more implementations, is multiplied by 1,000. Such calculations provide a fundamental and industry-based paradigm shift by providing output that is generated differently than in a traditional actuarial practice, which determines discrete categorized values as a function of one or more decision trees and that are effectively categorically distributed values. The present application provides for indexing on a continuous scale to determine a precise state of health.

In addition, and as noted herein, the present application is operable to run on partial data, and implements the imputation engine to generate values that are missing. Obtaining each of a plurality of values associated with assessing health can be burdensome, expensive, inconvenient and/or impractical. The imputation engine of the present application overcomes such shortcomings associated with various health platforms, such as in the insurance industry, by generating such missing values automatically. Benefits of the processes of the present application that are associated with assessing a user's health are significantly improved, including by reducing the number of questions that are required of participants and by speeding up the overall process.

Other benefits provided in accordance with the present application include achieving performance benchmarks, including by predicting all-cause mortality, cardiovascular mortality, and cancer mortality over a period of 10-14 years. Other conditions, such as diabetes and hypertension, may be less such as up to five years. Furthermore, the present application provides highly individualized output values, including by considering more than 100 health-related inputs representing well-being from various domains, including as blood biochemistry, anthropomorphic measurements, wellbeing, stress, nutrition, medical history, sleep, and physical activity. Furthermore, risk models that are provided in accordance with the present application can be derived and validated from observation, including from studies performed by groups of researchers, internationally. In addition, the present application supports straight-thru-processing (“STP”) that enables, for example, underwriting to occur substantially in real time. In this way, the present application enables users to offer liquid-free underwriting using the imputation engine and calculating risk assessment substantially automatically, even with limited amounts of data. Moreover, the features and operations shown and described herein support specific calibration and modulation in accordance with individuals in connection with pay-as-you-live (“PAYL”) and premium calculations.

It is recognized herein that long observation periods associated with one or more studies often do not lead to more accurate predictors. This is at least partly due to various elements, including those that a given model may or may not take into account, changing over time. It is very difficult or even impossible to unravel and understand the effects of such changes. For example, unpredictable lifestyle and/or environmental factors change over time, as do systems and methods for treating disease. Moreover, environmental conditions such as noise, light, and air pollution, and adverse weather, for example, are impactful on a person's health.

The Risk Engine of the present application improves predictive accuracy, including by defining a boundary, such as 10-15 years, which optimizes a balance between accuracy and inevitable changes in the many parameters that are invariably not accounted or omitted in known model-building processes. While some insurers use long-term risk estimates to generate their products, it is recognized that such estimates may be inaccurate for the reasons identified herein, as well as because certain risk factors (which change over time) are unknowable at baseline.

In one or more implementation, the Risk Engine of the present application takes into consideration and estimates a large and growing number of risks. For example, a non-limiting list of some of the risks include: Type 2 diabetes mellitus; hypertension; Metabolic syndrome; Index of Metabolic Dysfunction; chronic kidney disease; congestive heart failure; stroke; myocardial infarction; coronary heart disease; cancer; chronic obstructive pulmonary disease; neurologic dysfunction; and dementia. The accuracy of any estimates associated with such depends at least in part on the completeness of the input data. The Risk Engine of the present application has the distinct advantage over known systems by utilizing values generated by the imputation engine, thereby enabling the Risk Engine to function accurately and generate reasonable estimates of risk using minimal input data, including date of birth, gender, height and weight.

Accordingly, the Risk Engine of the present application generates risk estimates and scores, based on data and models from a large set of cohorts. This enables the ability to generate risks and scores that are generally valid for any person in the world. Risk estimates generated in accordance with the present application can be optimized for a given population.

The Risk Engine of the present application is usable to influence third party computing platforms, such as computing platforms associated with health insurance, life insurance and reinsurance providers. Risk estimation in existing insurance products, for example, including for robust actuarial and other methodologies, cannot achieve the degree of accuracy and precision that are available in accordance with the teachings herein. Nevertheless, the present application is not intended to be a substitute for methodologies or business approaches that are currently in place for the insurance industry. Instead, the present application, including the Risk Engine, provides a value-added service to the underwriting process by generating more accurate risk estimates in certain key areas, at a lower cost and greater convenience. This is particularly so for traditional approaches that rely on life tables at the center of risk-estimation.

In one or more implementations, a population-specific optimal model can be generated in a dataset that is split into two subsets, the Modeling Dataset, and the Prediction Dataset. The modeling dataset can be a subset of an optimization dataset that includes target field data. Further, this dataset is split during the process of model building into a training set, in which candidate models are derived, and a testing set in which models that are derived in the training set are tested. Robust model-building can proceed through a process of N-fold cross-validation, in which multiple Training/Testing set pairs are randomly selected from the Modeling Dataset to construct the model that best maximizes accuracy while also maximizing generalizability to minimize a likelihood of over-training. Typically, the Training and Testing Sets together contain around 70%-75% of the records from the full dataset prepared by the insurer. Finally, a third set, consisting of the rest of the Modeling Dataset records, the Prediction Set (also often called the Evaluation Set), is set aside to evaluate the properties of the final model in an unbiased manner. Both the split into a training set and testing set, and the use of n-fold cross-validation are data scientific techniques that can be used alternatively or in combination.

Further, the Prediction Dataset, sometimes referred to as the Blind Set, includes a subset of records from the Full Dataset in which target field(s) have been removed and set aside. Once an optimal model has been generated using data in the Modeling Dataset, the Prediction Dataset is scored using the optimal model. The score, representing the probability of a positive target value, is usable, for example, to evaluate the correctness of the modeling procedure, including all accuracy measures we report. Furthermore, population-specific optimization is supported, including for an end-point probability at a fixed time.

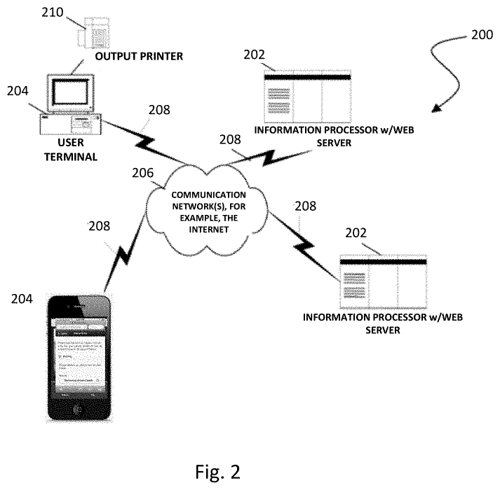

Referring FIG. 2, a diagram of an example hardware arrangement that operates for providing the systems and methods disclosed herein, and designated generally as health platform 200. Health platform 200 is preferably comprised of one or more information processors 202 coupled to one or more user computing devices 204 across communication network 206. User computing devices may include, for example, mobile computing devices such as tablet computing devices, smartphones, personal digital assistants or the like. Further, a plurality of sensing devices can be included that transmit various health-related information to computing devices, including directly or indirectly to information processor 202.

Information processor 202 preferably includes all necessary databases for the present application, including image files, metadata and other information. However, it is contemplated that information processor 202 can access any required databases via communication network 206 or any other communication network to which information processor 202 has access. Information processor 202 can communicate devices comprising databases using any known communication method, including a direct serial, parallel, USB interface, or via a local or wide area network.

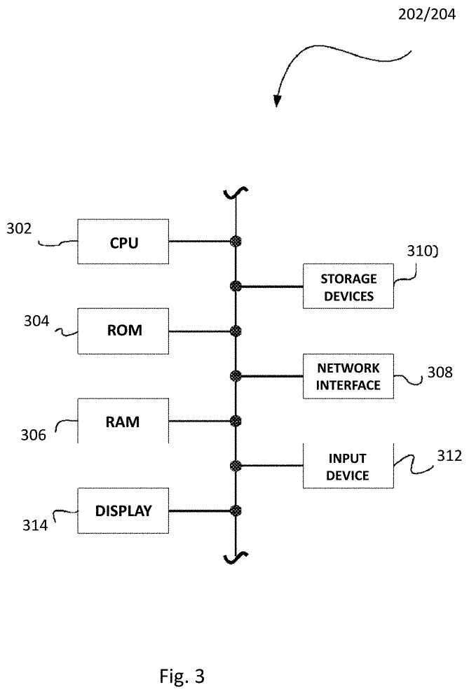

As shown in FIG. 3, the functional elements of each information processor 202 or workstation 204, which preferably include one or more central processing units (CPU) 302 used to execute software code in order to control the operation of information processor 202, read only memory (ROM) 304, random access memory (RAM) 306, one or more network interfaces 308 to transmit and receive data to and from other computing devices across a communication network, storage devices 310 such as a hard disk drive, flash memory, CD-ROM or DVD drive for storing program code, databases and application code, one or more input devices 312 such as a keyboard, mouse, track ball and the like, and a display 314.

The various components of information processor 202 need not be physically contained within the same chassis or even located in a single location. For example, as explained above with respect to databases which can reside on storage device 310, storage device 310 may be located at a site which is remote from the remaining elements of information processors 202, and may even be connected to CPU 302 across communication network 206 via network interface 308.

The functional elements shown in FIG. 3 (designated by reference numbers 302-314) are preferably the same categories of functional elements preferably present in user computing device 204. However, not all elements need be present, for example, storage devices and the capacities of the various elements are arranged to accommodate expected user demand. For example, CPU 302 in user computing device 204 may be of a smaller capacity than CPU 302 as present in information processor 202. Similarly, it is likely that information processor 202 will include storage devices 310 of a much higher capacity than storage devices 310 present in workstation 204. Of course, one of ordinary skill in the art will understand that the capacities of the functional elements can be adjusted as needed.

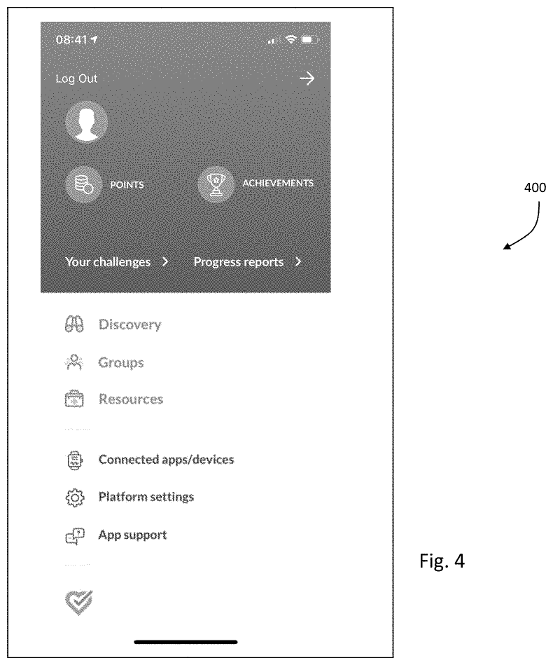

FIGS. 4-8 illustrate example screen displays that are associated with a graphical user interface that is operable provide features described herein. The screen displays illustrated in FIGS. 4-8 are associated with a mobile computing device, such as a smartphone, and include entering and reviewing data, e.g., via a graphical user interface via screen controls and submitted by the user. As shown in the display screen 400 shown in FIG. 4, graphical screen controls are selectable for a user who is currently logged in. Such controls include options for reviewing the user's profile information, current state of points, and achievements.

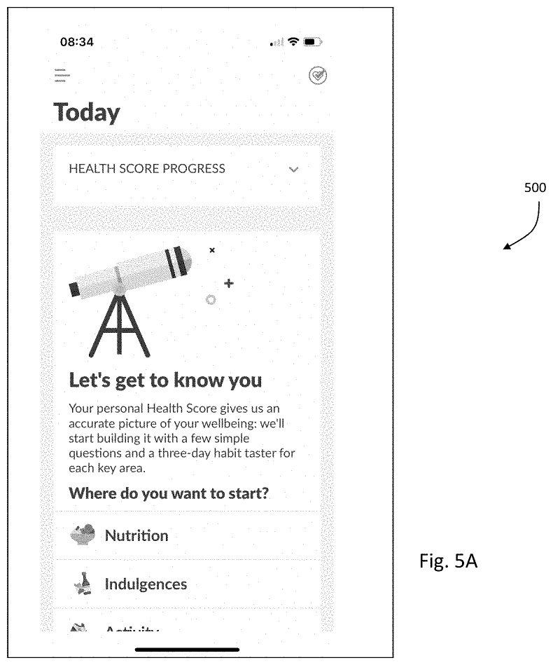

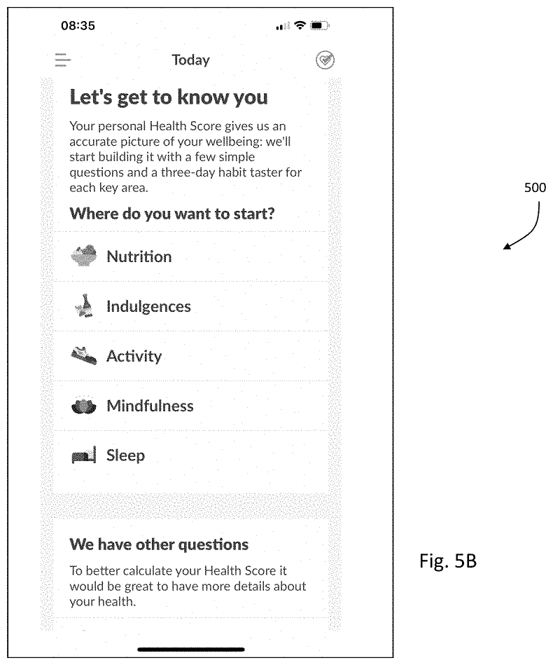

FIGS. 5A and 5B illustrate an example data entry display screen 500 that includes options associated with viewing progress associated with a user's MH Score 110, as well as to set parameters associated with nutrition, indulgences, activity, mindfulness, and sleep, all of which contribute to the MHM 102, as shown and described herein. Selection of any of the options lead to largely self-assessed values associated with the parameters, and assist in automatic generation of the MH Score 110. Moreover, a prompt is included for the user to provide responses to more detailed prompts associated with the user's health and lifestyle.

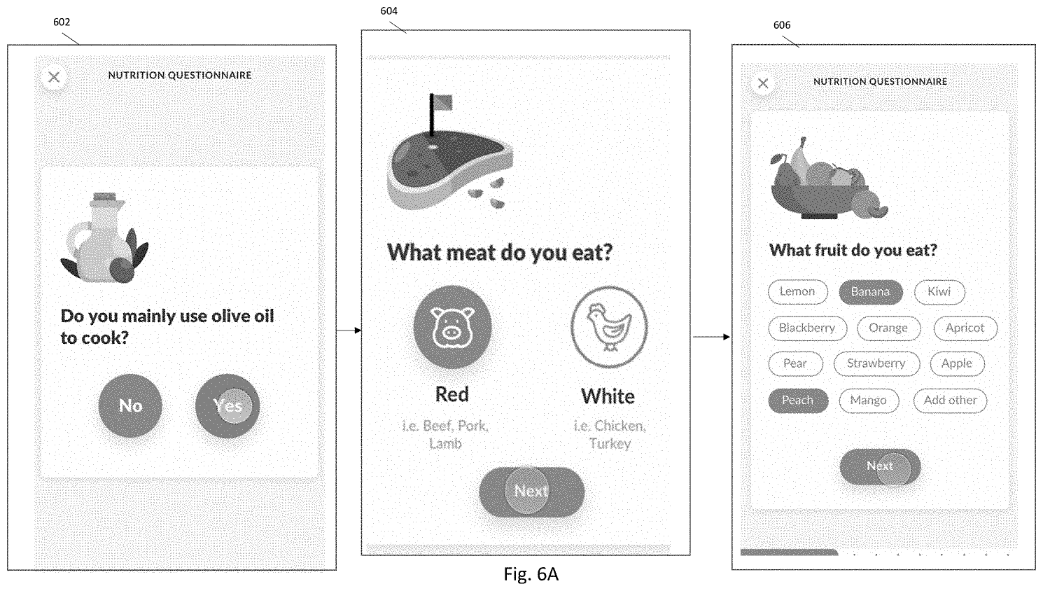

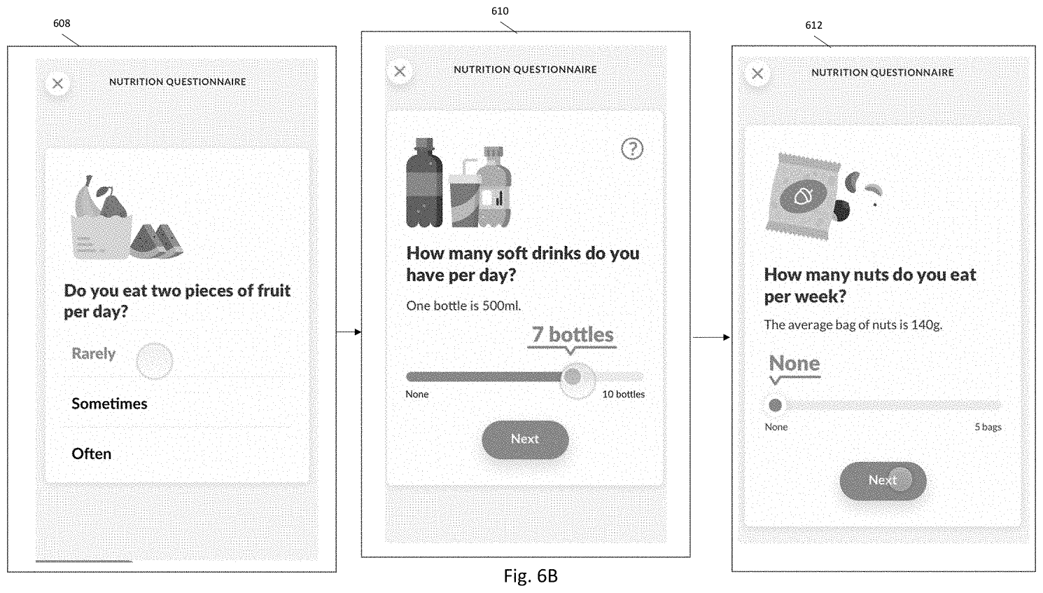

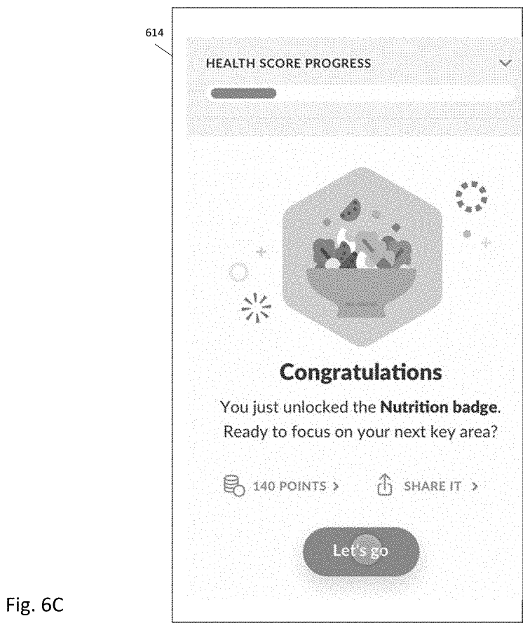

FIGS. 6A-6C illustrate a series of example data entry display screens 602, 604, 606, 608, 610, 612, and 614 (referred to herein, generally, as “cards”) that are provided for a user in response to a selection by the user of a respective option (in this case, nutrition) from display screen 500 (FIG. 5). FIGS. 6A-6C represent an example implementation of the present application in which example cards 602-614 provide interactive prompts for responses from the user for details regarding the user's food and eating habits, in order to obtain information for LHM 106, as well as to propose a brief (e.g., 3 day) miniature (“mini”) goals, such as to adjust the user's food intake in an organized plan and improve the user's MH Score 110. In one or more implementations, the selection and presentation of cards is based on complex artificial intelligence and machine-learned algorithms designed to maintain and/or improve a user's MH Score 110.

As shown in FIGS. 6A-6C, the user is prompted to identify whether the user mainly cooks with olive oil (card 602), what types of meat the user eats—red or white (card 604), types of fruit the user eats (card 606), how often the user eats two or more fruit servings per day (card 608), how many soft drinks the user has per day (card 610), and how many servings of nuts the user eats per week (card 612). In this way, a fun easy and convenient interface is provided for the user to submit health-related (in this case, food consumption) data. It is recognized herein that providing such food and habit-related other information can make users uncomfortable, which is reduced or eliminated by the convenient interface provided in accordance with the present application. Further, improvements to food-intake habits can be proposed in accordance with the present application, including to set modest goals that are easier to accomplish, such as a three-day mini goal to reduce consumption of sweets and/or increase consumption of healthy foods. Upon completion of cards 602-612, for example, and/or completion of one or more goals, a user is rewarded with positive reinforcement, such as by unlocking a “nutrition badge,” which gives the user a reward. In addition to a virtual reward, as shown in card 114, a financial or other redeemable reward can be provided in accordance with the present application, in response to the user completing various tasks such as providing details of the user's nutrition, indulgence, activity, mindfulness, and sleep habits, as well as detailed health information. Furthermore, such rewards can be provided as improvements in the user's health-related habits occur and are identified in accordance with the present application. One skilled in the art will recognize that the rewards system provided herein is a powerful tool to motivate users and boost long-term user engagement.

Example cards 602-614 are illustrative and the present application supports many such interactive navigation and self-prompting cards for receiving information in respective categories for modeling and generating information, as shown and described herein. For example, navigation modules and associated cards are supported for indulgences (e.g., smoking, drinking, etc.), activity (e.g., running, sports activity, etc.), quality of life (e.g., wellbeing), and sleep. Moreover, cards can be automatically provided to users in each of the respective categories to generate manageable tasks and encourage behavioral modifications, such as to reduce indulgences, increase activity, get more and better-quality sleep, and improve the user's mental state of health.

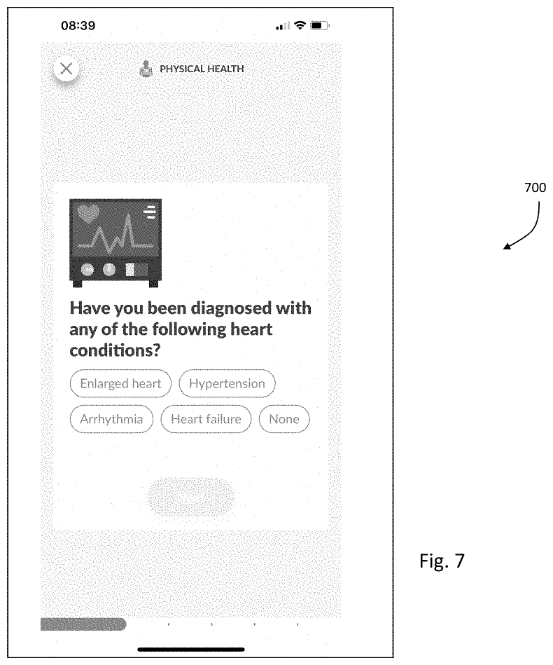

In addition to behavioral information, the present application provides cards to configure automatic collection and verification of health-related information. FIG. 7 illustrates an example data entry card 700 that is provided for a user who selected an option to provide additional, more granular information associated with the user's health. In the example shown in FIG. 7, the user is prompted to select whether the user had been diagnosed with any respective heart condition, such as enlarged heart, hypertension, arrhythmia, heart failure, and none. As a function of artificial intelligence, the user can be prompted through a series of engaging cards to provide significant amounts of information associated with the user's health. As noted herein, the present application includes functionality to ensure a user's health-related and behavioral information is maintained in strict confidence, and privacy is ensured as a function of security measures configured in computing software and hardware modules. Moreover, raw data elements that are received and/or imputed in accordance with the present application are maintained in background processes and only anonymous values generated as a function of modeling, such as shown and described herein, are viewable. The behavioral and medical values are transformed into a masked composite numerical value (e.g., the MH Score 110), and the values themselves are maintained privately and not published. Thus, underlying medical and behavioral parameters are protected so that a third party is not able to precisely reverse the calculation and determine those parameters based on values generated in accordance with modeling. In one or more implementations, a respective user and/or authorized person having sufficient access control permissions can access the underlying raw data elements.

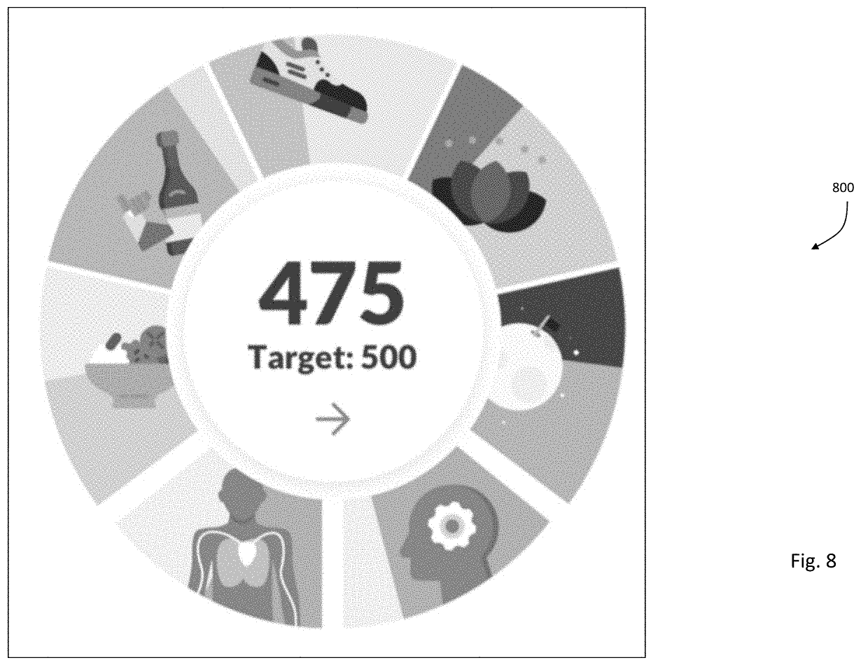

FIG. 8 illustrates an example display screen 800, referred to herein, generally, as a “Wheel of Life,” that is provided for a user to review progress, and includes the user's current Health Score and a target value that the user is trying to reach. The Wheel of Life illustrated in the example display screen 800 includes categories described herein, including activity, nutrition, indulgences, mindfulness, sleep, and medical details, each relating to the MHM 102, QLM 104 or LHM 106, and the MH Score 110. In one or more implementations, the categories shown in the display screen 800 are configured as selectable options. In use, a user selects a category which can cause one or more cards to appear for information display and/or entry. In addition, one or more of the respective categories can be automatically highlighted and/or selected to prompt the user, based on artificial intelligence, to review information associated with the user's health and/or to enter information that was partially entered, missing, or requires updating. Thus the Wheel of Life is useful as an information providing tool, as well as a hub for users to review and supply information.

Thus, as shown in the sample data entry display screens illustrated in FIGS. 4-8, a user can submit information associated with health and well-being, including via a convenient, attractive and fun interface. Additionally, the user can monitor his/her progress to maintain and/or improve his/her health, including as a function of the health score. Moreover, data that is received in accordance with the user interface can be transmitted and used in accordance with the present application in connection with modeling and outputting, as shown and described herein.

In one or more implementation, an interactive platform provides an easy stepping-stone towards a comprehensive view of human health and coaching for a conscientious and healthy lifestyle. The interactive platform can be implemented in a smartphone app, which integrated with the teachings herein. The platform motivates people to be physically active, including to increase the average number of daily steps, particularly for average individuals (as opposed to athletes).

In one or more implementations, a calculated score (referred to as the “Step Score”) is generated that is a risk-based function using information associated with physical activity and body mass index as key values. The values can be used, for example, to generate an all-cause ten-year mortality risk probability. Just as additional physical activity and lower adiposity reduce the risk of premature all-cause mortality, the Step Score of the present application increases under such conditions.

Preferably, the physical activity component of the Step Score is based on daily energy expenditure from taking steps. Input is calculated from the number of steps, step frequency, terrain grade, and stride length while at the same time providing instant gratification to the user by assigning more weight to present time as opposed to the past by virtue of the exponential moving average. Further, input is generated as MET hours per week by an exponential moving average so that local fluctuations in the daily energy input are smoothed, thereby generating a medically meaningful estimate of energy expenditure.

In one or more implementations, the Risk Model of the present application can include the Step Score. For example, central adiposity, using the body mass index (BMI) as proxy, plays two roles in the Step Score. First, through an all-cause mortality risk model described below that modulates the physical activity part of the score, and second, as an energy amplifier to encourage users with some degree of obesity. This booster function produces a maximum amplification factor at low energy expenditures and tails off exponentially as higher-BMI users increase their daily energy expenditures.

Further, an estimate of relative life expectancy is used with the Step Score as an additional inducement to users. The effects of both physical activity and obesity on longevity are taken into account. Estimates associated with relative years gained from increased physical activity, and relative years lost from obesity, are further used and combined. For example, relative years gained are estimated from physical activity from inactivity-based mortality estimates, and years lost due to obesity can be estimated relative to a broad ideal BMI centered around 23.5 kg/m2.

Accordingly, the present application is designed and built to induce lasting behavior change in users. Various incentives, such as premium reductions and/or a built-in store, provide an extrinsic motivation to get users to walk more. Features associated with the Step Score can be self-determined, and function as a reward system. For example, and in connection with a gaming implementation, value can be earned through game play and activity (e.g., walking). Thus, in one or more implementations, the application is configured as a location-based game that users choose to play. This provides an interesting choice, not a prescription, or a mandate, and therefore, more likely to result in behavioral change.

On the gamification side, a platform can be provided around a level system ranging from level 1 to 15. To advance in level, players need to earn experience points, or XP for short. Players can make progress merely by walking, as each step yields 1 XP. As they progress in level, additional features are unlocked: Step Score (Level 3); Quests (Level 2); Teams (Level 5); Abilities and Rewards (Levels 8, 10, 15). This turns the level system into a strong progress dynamic, in which every step counts. By walking, completing quests, participating in team battles, or the like, players earn XP, which advances the player in level and unlocks new features. Later in the game, players can earn coins which they can spend, such as in a reward shop. Additionally, the Step Score can be used to offer premium reductions.

In one or more implementations, the Step Score is unlocked at level 3. The Step Score includes two strongly motivational subsystems: a boost for players who are overweight; and a reservoir. Players fill the reservoir as they walk, which protects the Step Score from decaying if a player does not walk as much as usual for a day or two. Alternatively, walking more again after the Step Score drops and after the reservoir is exhausted, provides a strong motivation to walk more.

For those who are not particularly interested in gaming, using the Step Score and related premium reductions is believed to be a major attraction. Those users who do enjoy playing are offered more in the form of casual gaming and a reward shop.

In one or more implementations, the Quest System is unlocked at level 2. Players can walk to a quest appearing on the map at a point of interest, such as a store or public place. The quest asks them to complete a task, such as visiting a set of neighboring places. This particular quest may make players rediscover their neighborhood in a new way, all while walking and accumulating XP. Completing a quest awards additional XP, thus allowing players to increase their level more quickly.

At level 5, teams can be unlocked, and players can join a particular team (e.g., red or blue). Choosing a team allows players to battle for daily supremacy, such as by collecting gems appearing on a map or amassing a number of steps. During play, players walk to gems to pick them up. All active players in the winning team gain additional XP once the battle ends.

Thus, the game is social that emphasizes relatedness and collaboration; that is, actions having a meaning beyond oneself.

In addition, the Abilities System is designed to give players certain boosts, which the user must discover. In one or more implementations, earning XP becomes meaningless once players reach level 15. At this point, the Reward System can be fully unlocked. XP gains from quests and team wins become gains of coins, a virtual currency. Players can use coins accumulated over time to purchase rewards from a built-in store. Rewards provide a low-key, long-term motivation.

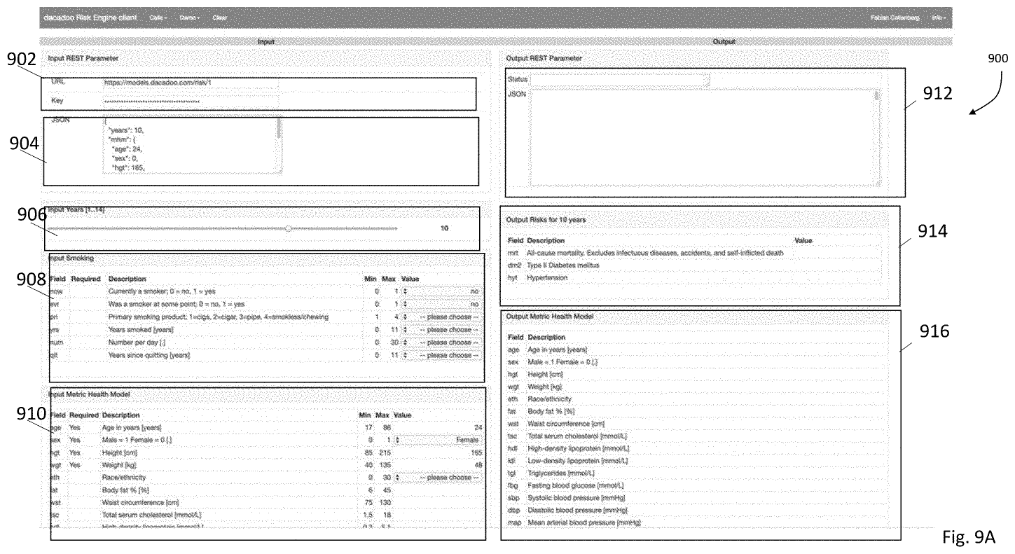

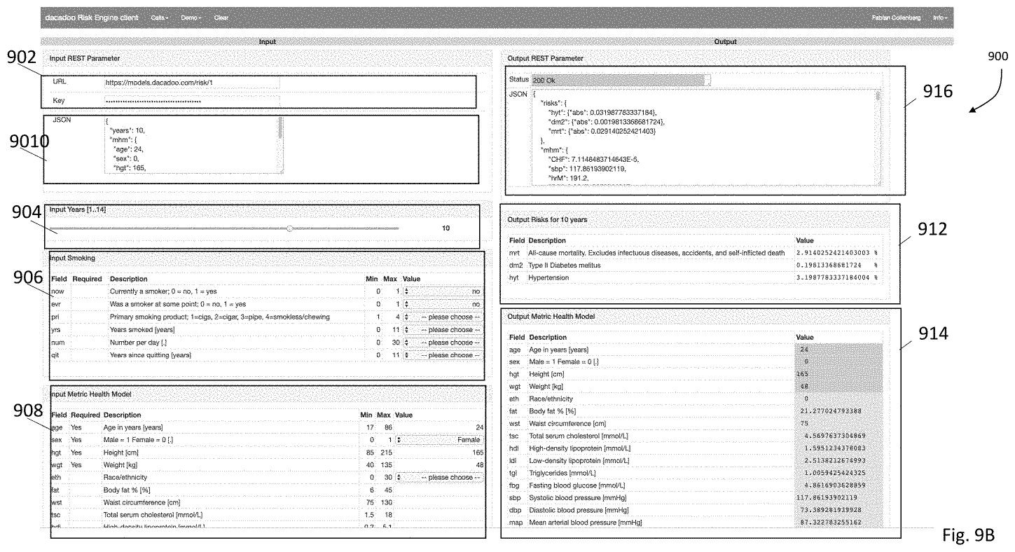

FIGS. 9A and 9B illustrate a sequence of operations in an example user interface 900 in accordance with an implementation of the present application. The sequence illustrated in FIGS. 9A and 9B illustrate data entry, editing, processing and conversion process in an implementation of the present application. It is recognized herein that automatic conversion of data, including from one data format to one or others is important, including to support foreign data platforms, transmitting information across continents, or the like.

Data values are shown in FIGS. 9A and 9B, which can be provided to interface 900 by users via graphical screen controls included in interface 900. In the example shown in FIGS. 9A and 9B, user credentials, such as a token issued by a respective key provider in section 902. As shown in example block 904, a prediction time frame (such as 10 years) is provided, and as shown in example blocks 906, and 908, data field names, field attributes (e.g., whether a value is required, data descriptions, minimum and maximum acceptable values), as well as data values are provided in interface 900. The inputs can be associated with MHM 102, QLM 104 (not shown) and/or LSM 106 (not shown). Blocks 904, 906, and 908 can include graphical screen controls, including slider controls, drop-down lists, or the like, for users to enter or adjust values.

In one or more implementations, after information is entered in interface 900, a data communication session is established, and data can be provided to information processor 202. JavaScript is usable to generate REST parameters and a JSON object (block 910) can be instantiated, which is passed to information processor 202 for processing. For example, information processor 202 parses values from the JSON object to calculate output in connection with the MHM 102, QLM 104, and LSM 106, as well as component models thereof, which regard a continuous probability space between 0 and 1. In another example, information processor 202 does not process or make calculations directly, but accesses the Risk Engine API, i.e. another computing device (including another information processor).

FIG. 9B illustrates a continuation in the sequence and interface 900 after values calculated by information processor 202 are returned and displayed in interface 900. For example, blocks 912 and 914 illustrate output representing risks for 10 years and other values from MHM 102, such as values that have been input and/or values that were not input but that have been imputed.

It is to be understood that the particular combination of an application, such as illustrated in FIGS. 9A and 9B, and related web server are just one out of a plurality of technological ways to access the Risk Engine API. For example, a spreadsheet, a data management system (e.g., an insurance policy management application or a health management system) can be connected to the Risk Engine API. Such connectivity can be provided in automated ways, such as a function of automated workflow management and rule-based processing. Furthermore, the information can be provided from one or more remote sources, such as from devices providing CSV or other suitably formatted data files. In one or more implementations, a device can connect to the Risk Engine API and then pass requests based on the information that are, for example, converted to JSON and then passed to the Risk Engine API.

Thus, as shown in the example sequence set forth in FIGS. 9A and 9B, client-side editing is supported (e.g., via blocks 904, 906, 908), which can occur with or without any active data communication session with information processor 202 or other suitable device. Data associated with the editing are passed to information processor 202 via parameter data included in a JSON object. Information processor posts results of MHM 102, QLM 104, and LSM 106 back to interface 900, and the information is converted, such as for display by one or more computing devices. Furthermore, the information can be downloaded in a file format such as CSV.

Accordingly, the present application engages and empowers users for sustained behavioral change that supports long-term health improvements. Automatically generated indications are provided that are associated with a user's well-being and health, substantially in real time. Furthermore, personal goals are defined to improve users' health, and information is automatically generated and provided that enables long-term health improvements and healthy lifestyles. The present application includes modules that interface with a multitude of IOT devices and computing devices, that support tracking, verification, and aggregation of information from disparate sources for modeling and provisioning into a single value. Using artificial intelligence and machine-learning, users' health is strengthened via an interactive computing platform that motivates users to engage in health lifestyles to improve or maintain overall health.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed:

1. A computer-implemented method for integrating modulated output from each of a plurality of models to quantify factors to generate a plurality of values, each within a continuous distribution, and selecting a respective discrete category associated with each of the values representing a likelihood of a future occurrence, the method comprising:
quantifying, by a first data model running on at least one computing device, each of a plurality of endpoints that contribute to a current state and the likelihood of the future occurrence, wherein each quantified value of the respective quantified endpoints is calculated within a continuous distribution;
generating, by a second data model running on the at least one computing device, respective values representing aspects of at least one present condition that impacts the likelihood of the future occurrence, wherein each of the respective generated values is within a continuous distribution;
identifying, by a third data model running on the at least one computing device, individual ones of a plurality of factors associated with a subset of the endpoints and/or the aspects that are individually modifiable, and generating a value within a continuous distribution representing each of the plurality of factors;
modulating, by a modulating model running on the at least one computing device, at least one value quantified by the first data model, generated by the second data model and/or identified by the third data model, to scale a value representing at least one aspect associated with the likelihood of the future occurrence, wherein the modulating is based on at least one factor derived from at least one of the first data model, the second data model, and the third data model; and
using at least one of artificial intelligence and machine learning comprised in the at least one computing device, to integrate at least two of the values associated with each of the plurality of continuous distributions, and selecting a respective discrete category associated with the integrated values, wherein each of the integrated values and the selected category represent the likelihood of a future occurrence.

2. The method of claim 1, further comprising:
imputing, by the at least one computing device, at least one value that is not included in a set of inputs used by the first data model.

3. The method of claim 2, further comprising:
imputing, by the at least one computing device, at least one other value that is not included in the previously imputed value(s) or the quantified value associated with the previously quantified endpoint, wherein the at least one other imputed value depends on at least one of the previously imputed values; and
wherein the imputed at least one other value is within a continuous distribution.

4. The method of claim 1, further comprising:
recalibrating at least one of the first data model, the second data model, and the third data model as a function of information received over time or information received from a plurality of data sources.

5. The method of claim 1, wherein the first data model uses the respective endpoints as input features in a fitting procedure.

6. The method of claim 1, further comprising:
configuring a user computing device with a software application that provides a graphical user interface on the user computing device, wherein the graphical user interface receives at least some of the values and the aspects from a user operating the user computing device;
receiving, by the at least one computing device from the user computing device over a data communication session, at least some of the values and aspects;
transmitting, by the at least one computing device to the user computing device, the quantified values associated with the at least some of the endpoints, the quantified values associated with the at least some of the aspects, and the generated values associated with at least some of the factors respectively from the first data model, the second data model, and the third data model;
wherein the user computing device is further configured by the software application to:
display the received values received from the at least one computing device.

7. The method of claim 1, further comprising:
configuring a user computing device with a software application that provides a graphical user interface on the user computing device, wherein the graphical user interface regularly and periodically prompts a user to enter values associated with the factors, and further wherein the graphical user interface automatically provides interactive display screens when values associated with the factors are not received subsequent to previously received values.

8. The method of claim 1, wherein at least one of the first data model, the second data model and the third data model comprise a selection of at least two other data models.

9. The method of claim 1, wherein the values are calculated in the continuous distribution as a function of parametric non-linear mapping.

10. A computer-implemented system for integrating modulated output from each of a plurality of models to quantify factors to generate a plurality of values, each within a continuous distribution, and selecting a respective discrete category associated with each of the values to represent a likelihood of a future occurrence, the system comprising:
a first data model running on a computing device that quantifies each of a plurality of endpoints that contribute to a current state and the likelihood of the future occurrence, wherein each quantified value of the respective quantified endpoints is calculated within a continuous distribution;
a second data model running on at least one computing device that generates respective values representing aspects of at least one present condition that impacts the likelihood of the future occurrence, wherein each of the respective generated values is within a continuous distribution;
a third data model running on the at least one computing device that identifies individual ones of a plurality of factors associated with a subset of the endpoints and/or the aspects that are individually modifiable, and generating a value within a continuous distribution representing each of the plurality of factors;
a modulating model running on the at least one computing device that modulates at least one value quantified by the first data model, generated by the second data model and/or identified by the third data model, to scale a value representing at least one aspect associated with the likelihood of the future occurrence, wherein the modulating is based on at least one factor derived from at least one of the first data model, the second data model, and the third data model; and
at least one of artificial intelligence and machine learning comprised in the at least one computing device that integrates at least two of the values associated with each of the plurality of continuous distributions, and selects a respective discrete category associated with the integrated values, wherein each of the integrated values and the selected category represent the likelihood of a future occurrence.

11. The system of claim 10, further comprising:
at least one computing device configured to impute at least one value that is not included in a set of inputs used by the first data model.

12. The system of claim 11, wherein the at least one computing device is further configured to impute at least one other value that is not included in the previously imputed value(s) or the quantified value associated with the previously imputed endpoint, wherein the at least one other imputed value depends on at least one of the previously imputed values, and
further wherein the imputed other endpoint is within a continuous distribution.

13. The system of claim 10, further comprising:
at least one computing device configured to recalibrate at least one of the first data model, the second data model, and the third data model as a function of information received over time or information received from a plurality of data sources.

14. The system of claim 10, wherein the first data model uses the respective endpoints as input features in a fitting procedure.

15. The system of claim 10, further comprising:
a software application that, when executed on a user computing device, causes the computing device to:
provide a graphical user interface that receives at least some of the values and the aspects from a user operating the user computing device;
receive the quantified values associated with the at least some of the endpoints, the quantified values associated with the at least some of the aspects, and the generated values associated with at least some of the factors respectively from the first data model, the second data model, and the third data model; and
display the received values.

16. The system of claim 10, further comprising:
a software application that, when executed on a user computing device, causes the computing device to:
provide a graphical user interface that regularly and periodically prompts a user to enter values associated with the factors, and further wherein the graphical user interface automatically provides interactive display screens when values associated with the factors are not received subsequent to previously received values.

17. The system of claim 10, wherein at least one of the first data model, the second data model and the third data model comprise a selection of at least two other data models.

18. A computer-implemented method for integrating modulated output from each of a plurality of models to quantify factors to generate a plurality of values, each within a continuous distribution, the method comprising:
quantifying, by a first data model running on a computing device, each of a plurality of endpoints that contribute to a current state and the likelihood of the future occurrence, wherein each quantified value of the respective quantified endpoints is calculated within a continuous distribution;
generating, by a second data model running on at least one computing device, respective values representing aspects of at least one present condition that impacts the likelihood of the future occurrence, wherein each of the respective generated values is within a continuous distribution;
identifying, by a third data model running on the at least one computing device, individual ones of a plurality of factors associated with a subset of the endpoints and/or the aspects that are individually modifiable, and generating a value within a continuous distribution representing each of the plurality of factors; and
modulating, by a modulating model running on the at least one computing device, at least one value quantified by the first data model, generated by the second data model and/or identified by the third data model to scale a value representing at least one aspect associated with the likelihood of the future occurrence, wherein the modulating is based on at least one factor derived from at least one of the first data model, the second data model, and the third data model.

19. The method of claim 18, further comprising:
selecting a respective discrete category, wherein the selected category represents the likelihood of a future occurrence.

20. The method of claim 18, further comprising:
integrating at least two of the values associated with each of the plurality of continuous distributions, and selecting a respective discrete category associated with the integrated values, wherein each of the integrated values and the selected category represent the likelihood of a future occurrence.

21. The method of claim 20, wherein at least one of integrating the at least two of the values and selecting the respective discrete category is performed using at least one of artificial intelligence and machine learning.

22. The method of claim 18, wherein at least one of the first data model, the second data model, and the third data model comprise at least one of artificial intelligence and machine learning.
